(19) United States
(12) Patent Application Publication
(10) Pub. No.: US 2006/0100321 A1
(43) Pub. Date: May 11, 2006

(54) Method for improving physico-chemical properties of bitumen compositions, said compositions and uses thereof

(76) Inventors: Gilles Orange, Soisy Sous Montmorency (FR); Daniel Joubert, Vineuil Saint Firmin (FR); Francisco Reig Sanchez-Giron, Barcelona (ES)

Correspondence Address: MCCARTER & ENGLISH LLP;CITYPLACE I, 185 ASYLUM STREET, HARTFORD, CT, 06103, US

(21) Appl. No.: 10/518,104

(22) PCT Filed: Jun. 6, 2003
(86) PCT No.: PCT/FR03/01706

§ 371 Date: Aug. 26, 2005

(30) Foreign Application Priority Data
Jun. 10, 2002 (FR) 02/07088

(51) Int. Cl. C08L 95/00

(52) U.S. Cl. 524/59

(57) ABSTRACT

The present invention relates to a process for improving the physicochemical properties of bitumen compositions and also to novel bitumen compositions with improved properties and to their uses in a process for preparing hot bitumen mixes or in a process for preparing cold bitumen mixes.

The present invention relates to a process for improving the physicochemical properties of bitumen compositions and also to novel bitumen compositions with improved properties and to their uses in a process for preparing hot bitumen mixes or in a process for preparing cold bitumen mixes.

It is known practice to use materials of bitumen type, such as asphalt and maltha for road surfaces, roofing materials, various coatings, mortar and bends.

Bitumen compositions have been prepared by adding suitable additives such as aggregates or fillers to the materials of bitumen type mentioned above.

However, such compositions have many drawbacks when they are used as obtained for various applications: mention may be made especially of high temperature sensitivity, low adhesion with respect to aggregates, poor properties at low temperature, low abrasion resistance and low impact strength.

Thus, in the case of a road surface, the main constituents are bitumen mixes consisting of 95% by mass of granulates and 5% by mass of bitumen acting as binder.

This binder has a predominant role on the properties of the road, which is subjected to three types of stress of mechanical origin: thermal fracturing, fatigue and tracking.

At low temperature (about −20° C.), the binder, i.e. the bitumen, vitrifies and becomes brittle. Long transverse tracks may then form, caused by the thermal stresses (thermal fractures), which are microcracks caused by the heterogeneity of the material.

At a higher temperature (about 0° C.), the road surface can still crack under the effect of fatigue. This results in a multitude of mainly longitudinal interconnected cracks.

Finally, at higher temperatures (about 50° C.), the repeated loads created by vehicles on the road surface contribute towards forming tracks.

The binder also ensures impermeablization of the road surface, thus protecting the road substructure.

The main characteristics required for the road and thus for the bitumen composition acting as binder are thus:

good resistance to cracking at low temperature (typically −30° C.),

low deformation at high temperature (typically +60° C.),

good fatigue strength to improve the durability.

It is also known practice to improve the properties of bitumen by making suitable additions.

Thus, by adding a rubber component, the temperature sensitivity is reduced and the adhesion of the binder with respect to the aggregates and the abrasion resistance are greater; furthermore, the low-temperature properties of the bitumen are appreciably improved, and thus, for example, flexibility is provided, and similarly the high-temperature properties are improved: the shape stability and the impact strength are thus improved.

Natural rubber or a styrene-butadiene copolymer rubber in solid form or in latex form are mainly conventionally used as rubber to obtain such a modified bitumen composition.

However, when a rubber in solid form is used, fusion in a material of bitumen type demands heating for a long period, and problems arise, for instance the degradation of the rubber component and of the bitumen material.

On the other hand, a rubber in the form of an aqueous polymer dispersion (latex) may readily be mixed with a material of bitumen type. As regards the workability and the mixing time, rubber latices are generally used.

However, when an aqueous polymer dispersion (latex) of natural rubber is added to asphalt, the viscosity increases over time as if the entire system had gelled, resulting in implementation problems.

Furthermore, when an aqueous polymer dispersion (latex) of rubber is added to bitumen that has been fused at high temperature, in the case most frequently encountered for producing hot bitumen mixes, which consists in hot-spreading a mixture of the various constituents (gravel and bitumen), a sudden generation of vapour is observed, which may constitute a hazard for the users.

Similarly, when an aqueous polymer dispersion (latex) of rubber is added to bitumen in a bitumen-in-water emulsion (60-70% bitumen) which is spread onto the road before spreading the granulates, as is the case in the production of “cold” mixes, the latex introduces an additional amount of water that disrupts the production of the cold mix.

The present invention was developed in order to solve the problems mentioned above.

One of the aims of the present invention is to provide a process for improving the properties of bitumen compositions that do not have the drawbacks mentioned above.

Another aim of the present invention is to provide a process for improving the rheological and mechanical properties of bitumen compositions.

Another aim of the present invention is to provide a process for improving the mechanical properties of bitumen compositions at low temperatures.

Another aim of the present invention is to provide a process for improving the properties of bitumen compositions, which is easier to implement and involves fewer safety hazards both in the preparation of hot bitumen mixes and in the preparation of cold bitumen emulsions.

Another aim of the present invention is to provide a process for improving the properties of bitumen compositions, which exhibits ease of storage and good redispersibility of the additives used in the bitumen compositions.

These aims and others are achieved by the present invention, which concerns, specifically, a process for improving the physicochemical properties of bitumen, characterized in that a sufficient amount of polymer powder with a particle size of between 1 and 150 μm is added to the bitumen composition.

The present invention also relates to a bitumen composition that may be obtained by the process.

The present invention also relates to a process for preparing hot mixes using the bitumen composition of the invention.

The present invention also relates to a process for preparing cold mixes which uses the bitumen composition of the invention.

The present invention relates firstly to a process for improving the physicochemical properties of bitumen, characterized in that a sufficient amount of polymer powder with a particle size of between 1 and 150 μm is added to the bitumen composition.

The pulverulent composition of water-insoluble film-forming polymer used in the process of the invention may be prepared by any method for preparing redispersible polymer powders known to those skilled in the art in the construction sector.

Thus, the film-forming polymer is prepared from at least one ethylenically unsaturated monomer, which may be chosen from: styrene, butadiene, C₁-C₁₂ alkyl acrylic and/or methacrylic esters, vinyl esters, acrylamide and/or methacrylamide, and C₁-C₁₂ alkyl derivatives thereof. Preferably, the composition may comprise styrene and butadiene, as ethylenically unsaturated monomers.

Furthermore, a monomer containing one or more functional group(s) may be included as additional monomer. In general, the film-forming polymers in the form of an aqueous dispersion (latex) or in the form of redispersible powders are not stable to polymerization or to storage if they do not contain anionic hydrophilic groups at the surface of the particles.

For this reason, these groups are introduced during the emulsion polymerization by adding functionalized monomers.

Examples of functional groups comprise carboxyl, acid anhydride, hydroxyl, amide, amino and glycidyl groups, and among these, carboxyl groups are preferred.

Examples of monomers containing one or more carboxyl group(s) comprise ethylenically unsaturated monocarboxylic or polycarboxylic acids. Among the ethylenically unsaturated monocarboxylic acids that may be mentioned are acrylic acid and methacrylic acid, or a mixture thereof. Examples of ethylenically unsaturated polycarboxylic acids include ethylenically unsaturated dicarboxylic acids, especially fumaric acid, itaconic acid, crotonic acid, maleic acid, maleic anhydride, mesaconic acid and glutaconic acid, or mixtures thereof.

Examples of monomers containing one or more amide group(s) include ethylenically unsaturated carboxylic acid alkylamides, such as methacrylamide, N-methylolmethacrylamide, diacetone acrylamide, ethacrylamide, crotonamide, itaconamide, methylitaconamide and maleic acid monoamide; examples of monomers containing one or more amine group(s) include aminoethyl (meth)acrylate, dimethylaminoethyl (meth)acrylate, vinyl β-aminoethyl ether and vinyl dimethylaminoethyl ether; examples of monomers containing one or more glycidyl group(s) include glycidyl esters of ethylenically unsaturated carboxylic acids, such as glycidyl (meth)acrylate; examples of monomers containing both one or more amine group(s) and one or more amide group(s) include ethylenically unsaturated carboxylic acid aminoalkylamides, such as aminoethylacrylamide, dimethylaminomethylmethacrylamide and methylaminopropylmethacrylamide; and examples of monomers containing one or more glycidyl group(s) include glycidyl esters of ethylenically unsaturated carboxylic acids, such as glycidyl (meth)acrylate. These monomers containing one or more functional group(s) may be used alone, or alternatively two or more monomers may be used in combination.

Among these additional monomers, ethylenically unsaturated carboxylic acids are preferred.

Advantageously, the film-forming polymer used in the invention is prepared from styrene, butadiene and acrylic acid monomers.

Preferably, the film-forming polymer is prepared by polymerizing a monomer mixture comprising 92% to 99.9% by weight of at least one ethylenically unsaturated monomer, and 0.1% to 8% and more particularly 2% to 5% by weight of at least one monomer containing a carboxylic function.

The proportions and nature of the ethylenically unsaturated monomers used in the polymerization are chosen by persons skilled in the art so as to obtain a glass transition temperature that is suitable for the intended use.

Thus, in the present invention, the proportions and nature of the monomers used are chosen so as to obtain a glass transition temperature for the polymer of between −40° C. and 35° C.

Preferably, the proportions and nature of the monomers used are chosen so as to obtain a glass transition temperature of between −40° C. and 5° C.

Even more preferably, the proportions and nature of the monomers used are chosen so as to obtain a glass transition temperature of between −40° C. and 1° C.

The reason for this selection arises from the fact that the mechanical properties under cold conditions, i.e. at a temperature in the region of −30° C., of the bitumen composition into which is incorporated a sufficient amount of polymer powder according to the process of the invention, are markedly improved when the said polymer has a glass transition temperature that is within the intended temperature range.

The polymer powder of the present invention may be obtained by performing an emulsion polymerization of the monomers mentioned above in an aqueous medium, which produces an aqueous polymer dispersion (latex), followed by removing the water from the latex obtained.

Such a polymerization is usually performed in the presence of an emulsifier and a polymerization initiator.

The monomers may be introduced as a mixture, or separately and simultaneously, into the reaction medium, either before the start of the polymerization in a single step or during the polymerization in successive fractions or continuously.

Emulsifiers generally used include the standard anionic agents represented especially by fatty acid salts, alkyl sulphates, alkyl sulphonates, alkylaryl sulphates, alkylaryl sulphonates, aryl sulphates, aryl sulphonates, sulphosuccinates, and alkyl phosphates of alkali metals. They are used in a proportion of from 0.01% to 5% by weight relative to the total weight of the monomers.

The emulsion polymerization initiator, which is water-soluble, is more particularly represented by hydroperoxides such as hydrogen peroxide and tert-butyl hydroperoxide, and by persulphates such as sodium persulphate, potassium persulphate and ammonium persulphate. It is used in amounts of between 0.05% and 2% by weight relative to the total weight of the monomers.

Depending on the initiator used, the reaction temperature is generally between 0 and 100° C. and preferably between 50 and 80° C.

A transfer agent may be used in proportions ranging from 0 to 3% by weight relative to the total weight of the monomers, this agent generally being chosen from mercaptans such as n-dodecyl mercaptan, tert-dodecyl mercaptan and tert-butyl mercaptan, and esters thereof, for instance methyl mercaptopropionate, cyclohexene, and halogenated hydrocarbons such as chloroform, bromoform and carbon tetrachloride.

The size of the particles of the emulsion of film-forming polymer may be between 0.02 μm and 5 μm and preferably between 0.08 μm and 1 μm.

As regards the emulsion polymerization process and the conditions thereof, there are no particular limits and the emulsion polymerization may be performed using conventional processes and conditions known to those skilled in the art.

During the implementation of the emulsion polymerization, besides the polymerization initiator, the emulsifier and the chain-transfer agent mentioned above, a chelating agent, a pH regulator, and an electrolyte or equivalent may also be used, if necessary.

In the present invention, as regards the processes for removing the water from the polymer latex so as to obtain a powder in dry form, mention may be made of spray-drying processes, moderate-flow drying processes and freeze-drying and vacuum-drying processes. Among these, the spray-drying processes are particularly preferred in terms of efficacy and production cost. The spray-drying is generally performed at 50-170° C. and preferably 70-120° C., using a machine such as a hydraulic twin-nozzle atomizer, a pressure-nozzle atomizer or a rotary disc atomizer.

The spray-drying conditions, such as the inlet temperature, the outlet temperature, the air flow and the flow rate, are suitably selected depending on the type, composition, glass transition temperature and the total solids content ratio of the latex.

As regards the polymer powder used in the present invention, the particle diameter is between 1 and 150 μm and preferably between 50 and 150 μm. When the particle diameter of the polymer powder is less than 1 μm, the powder becomes difficult to handle, which results in poor workability during the application. On the other hand, when the diameter is greater than 150 μm, it shows poorer redispersibility.

Thus, with the aim of producing a polymer powder that is particularly suitable for the present invention, it is preferable to use a powder preparation process as described in document WO 99/38917, which is incorporated by reference.

In summary, this process consists in removing the water from an aqueous dispersion of water-insoluble film-forming polymer particles (B) as described above, also comprising suitable amounts of polypeptide (A), optionally of amino acid (D), of partially or totally water-soluble protein (E) or a mixture thereof, of water-soluble compound (C) and of mineral filler (F), the said film-forming polymer being prepared from at least one ethylenically unsaturated monomer and from at least one ethylenically unsaturated monomer containing a carboxylic function.

The dry residue thus obtained may optionally be ground or disintegrated to a powder of desired particle size.

All the definitions of the constituents (A), (C), (D), (E) and (F) and also the amounts used and the preparation conditions are specified in the said document WO 99/38917, which is incorporated by reference.

The polypeptide (A) is incorporated in an amount of between 2 and 40 parts by weight per 100 parts by weight of water-insoluble film-forming polymer powder prepared from at least one ethylenically unsaturated monomer and from at least one ethylenically unsaturated monomer containing a carboxylic function, the said polypeptide (A) containing from 2 to 100 amino acids.

The term “polypeptide” means a molecule formed from a sequence of at least two amino acids. In the context of the present invention, the polypeptide (A) contains from 2 to 100 amino acids and preferably from 4 to 50 amino acids.

The polypeptide (A) forming part of the composition according to the invention is at least partially water-soluble. Advantageously, the water-soluble part of the polypeptide (A) may represent at least 2 parts by weight relative to the polymer.

The constituent amino acids of the polypeptide may be chosen from any natural and/or synthetic amino acid. They are chosen especially from alanine, arginine, asparagine, aspartic acid, cysteine, glutamic acid, glycine, histidine, isoleucine, leucine, lysine, methionine, phenylalanine, proline, serine, threonine, tryptophan, tyrosine and valine, and derivatives thereof.

The expression “derivatives of the constituent amino acids of the polypeptide” more particularly denotes the water-soluble or water-alkali-soluble salts of the amino acids. They may be, for example, sodium, potassium and ammonium salts.

Examples that may be mentioned include sodium glutamate, sodium aspartate and sodium hydroxyglutamate.

The polymer powder may also optionally comprise at least one water-soluble compound (C). This compound may be chosen from sugars and derivatives thereof, and polyelectrolytes belonging to the family of weak polyacids. Compound (C) is more particularly a solid.

When compound (C) is chosen from polyelectrolytes belonging to the family of weak polyacids, per 100 parts by weight of film-forming polymer powder (B), the pulverulent composition according to the invention may comprise from 5 to 20 parts by weight, preferably from 5 to 15 parts by weight and even more preferably between 2 and 10 parts by weight of water-soluble compound (C).

The polyelectrolytes may be of organic nature, derived from the polymerization of monomers having the general formula below: 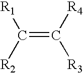
in which formula R₁, which may be identical or different, represent H, CH₃, CO₂H, (CH₂)ₙCO₂H with n=0 to 4.

Non-limiting examples that may be mentioned include acrylic acid, methacrylic acid, maleic acid, fumaric acid, itaconic acid and crotonic acid.

The copolymers obtained from the monomers corresponding to the general formula above and those obtained using these monomers and other monomers, in particular vinyl derivatives, for instance vinyl alcohols and copolymerizable amides, for instance acrylamide and methacrylamide, are also suitable for the invention. Mention may also be made of the copolymers obtained from alkyl vinyl ether and from maleic acid, and also those obtained from vinylstyrene and from maleic acid, which are described especially in the Kirk-Othmer encyclopaedia entitled “Encyclopedia of Chemical Technology”—Volume 18—3rd Edition—Wiley Interscience Publication—1982.

The preferred polyelectrolytes have a low degree of polymerization. The weight-average molecular mass of the polyelectrolytes is more particularly less than 20 000 g/mol. It is preferably between 1 000 and 5 000 g/mol.

The water-soluble compound (C) may also be chosen from sugars and derivatives thereof, alone or as a mixture. Oses (or monosaccharides), osides and polyholosides that are highly depolymerized are suitable in this respect. Compounds with a weight-average molecular mass that is more particularly less than 20 000 g/mol are intended.

Among the oses that may be mentioned are aldoses such as glucose, mannose, galactose and ribose, and ketoses such as fructose.

The osides are compounds that result from the condensation, with elimination of water, of ose molecules with each other or alternatively of ose molecules with non-carbohydrate molecules. Among the osides that are preferred are holosides, which are formed by combining exclusively carbohydrate units and more particularly oligoholosides (or oligosaccharides) that comprise only a limited number of these units, i.e. a number generally less than or equal to 10. Examples of oligoholosides that may be mentioned include sucrose, lactose, cellobiose, maltose and trehalose.

The highly depolymerized polyholosides (or polysaccharides) that are suitable are described, for example, in the book by P. Arnaud entitled “Cours de Chimie Organique”, published by Gaultier-Villars, 1987. More particularly, polyholosides with a weight-average molecular mass that is more particularly less than 20 000 g/mol are used.

Non-limiting examples of highly depolymerized polyholosides that may be mentioned include dextran, starch, xanthan gum and galactomannans such as guar or carob. These polysaccharides preferably have a melting point of greater than 100° C. and a water solubility of between 50 and 500 g/l.

When the water-soluble compound (C) is chosen from sugars and derivatives thereof, per 100 parts by weight of film-forming polymer powder (B), the pulverulent composition may comprise from 7 to 50 parts by weight and preferably from 8 to 25 parts by weight of water-soluble compound (C).

Needless to say, it is entirely possible to envisage using these various types of water-soluble compound, i.e. the sugars and derivatives thereof, and the polyelectrolytes belonging to the family of weak polyacids, in combination.

The redispersible pulverulent composition may optionally also comprise at least one amino acid (D), or a derivative thereof. The amino acid (D) is chosen from:
monocarboxylated monoamino acids, or
dicarboxylated monoamino acids, or
monocarboxylated diamino acids.

The amino acid (D) preferably contains a side chain with acid-base properties, chosen especially from arginine, lysine, histidine, glutamic acid, aspartic acid and hydroxyglutamic acid.

The abovementioned amino acids (D) may also be in the form of derivatives thereof and especially in the form of water-soluble or water-alkali-soluble salts. They may be, for example, sodium, potassium and ammonium salts. Examples that may be mentioned include sodium glutamate, sodium aspartate and sodium hydroxyglutamate. The redispersible pulverulent composition may optionally also comprise at least one partially or totally water-soluble protein (E), or a protein made at least partially water-soluble by known methods, which are often commercial products.

They may be, for example:

proteins derived from protein-yielding seeds, especially those of pea, of bean, of lupin, of haricot and of lentil; proteins derived from cereal grain, especially those of wheat, of barley, of rye, of maize, of rice, of oat and of millet; proteins derived from oil-yielding seeds, especially those of soybean, of groundnut, of sunflower, of rapeseed and of coconut; proteins derived from leaves, especially of alfalfa and of nettle; and proteins derived from underground plant storage organs, especially those of potato and of beetroot,

proteins of animal origin; examples that may be mentioned include muscle proteins, especially the proteins of the stroma, and gelatin; proteins derived from milk, especially casein and lactoglobulin; and fish proteins,

proteins produced by microorganisms, and preferably those that can especially use starch, cellulose, carbon dioxide, hydrocarbons and alcohols as a carbon source.

The partially or totally water-soluble protein (E) is more particularly of animal origin, preferably lactoglobulin.

Needless to say, it is possible to have a redispersible pulverulent composition comprising a mixture of amino acid (D) and of protein (E). It will then be necessary to ensure beforehand the compatibility between the various components of the pulverulent composition of the invention.

A second possible variant arising from document R98015 consists in using a pulverulent composition comprising a polypeptide (A) obtained by chemical or enzymatic hydrolysis of proteins derived from soybean or from wheat, and a polymer (B) prepared from styrene, butadiene and acrylic acid monomers, and a protein (E) which is lactoglobulin.

In order to promote the preparation of the powder and its stability on storage while avoiding the aggregation or caking of the powder, the pulverulent composition may optionally also comprise a mineral filler (F) with a particle size of less than 20 μm.

The mineral filler (F) recommended for use is a filler chosen especially from silica, calcium carbonate, kaolin, barium sulphate, titanium oxide, talc, hydrated alumina, bentonite and calcium sulphoaluminate (satin white).

Per 100 parts by weight of water-insoluble film-forming polymer powder (B), the amount of mineral filler (F) may be between 0.5 and 60 parts by weight and preferably between 10 and 20 parts by weight.

The mineral filler (F) may be added to the starting aqueous polymer dispersion. All or some of the mineral filler may also be introduced during the spraying step in the spray-drying process. It is also possible to add the mineral filler directly to the final pulverulent composition, for example in a rotary mixer.

Preferably, all or some of the mineral filler may also be introduced during the spraying step in the spray-drying process.

According to one preferred mode, small mineral particles, for example of about 3 μm, may be introduced into the spraying tower, in an amount such that, on leaving the atomizer, the pulverulent composition has a particle content of about 10% by weight.

The advantage of using this particular polymer powder is that it is very stable on storage, very workable, very fluid, does not cake and redisperses particularly well in bitumen compositions, which facilitates the implementation of the processes for preparing bitumen compositions with improved performance qualities and the processes for preparing “hot” bitumen mixes and “cold” bitumen mixes.

The polymer powder should be added to the bitumen composition in a sufficient amount.

For the purposes of the present invention, the term “sufficient amount” means an amount that is sufficient to substantially improve the physicochemical properties of the bitumen compositions.

In general, the amount of polymer powder introduced into the bitumen composition is between 0.5% and 20% by weight of dry powder relative to the weight of the bitumen composition. Preferably, this amount is between 0.5% and 10% by weight of dry powder relative to the weight of the bitumen composition. Even more preferably, this amount is between 0.5% and 3% by weight of dry powder relative to the weight of the bitumen composition.

It should be noted that examples of bitumens to which the polymer powder of the present invention may be added include natural bitumens, pyrobitumens and artificial bitumens. Bitumens that are particularly preferred are those used for road surfaces, such as asphalt or maltha. Even more preferably, asphalt is used.

Two embodiments are possible for incorporating the polymer powder into the bitumen composition.

The first embodiment concerns a process for improving the physicochemical properties of the bitumen composition, comprising the following steps:

1—the bitumen composition is heated to a temperature of between 140 and 190° C.;

2—a sufficient amount of polymer powder with a particle size of between 1 and 150 μm is added to the bitumen composition of step 1 with stirring.

The present invention also relates to a bitumen composition that may be obtained by the process described above.

The present invention also relates to a process for preparing hot mixes, which uses the bitumen composition that may be obtained by the above process.

This process comprises a step additional to the above process, which consists in adding, with stirring and at a temperature of between 140 and 190° C., the aggregates to the bitumen composition.

The second possible embodiment for incorporating the polymer powder into the bitumen composition is performed at room temperature. This is a process for preparing “cold” mixes.

This process includes the following steps:

1—a sufficient amount of polymer powder is incorporated into a bitumen emulsion with stirring at room temperature;

2—the emulsion obtained in step 1 is spread onto a road to obtain a uniform layer of the mixture obtained in step 1;

3—the aggregates and fillers are spread on top of the layer obtained in step 2 in the form of a uniform layer;

4—the bitumen emulsion is broken.

For the purposes of the present invention, the term “sufficient amount” means an amount that is sufficient to substantially improve the physicochemical properties of the bitumen compositions.

In general, the amount of polymer powder introduced into the bitumen composition is between 0.5% and 20% by weight of dry powder relative to the weight of the bitumen composition. Preferably, this amount is between 0.5% and 10% by weight of dry powder relative to the weight of the bitumen composition. Even more preferably, this amount is between 0.5% and 3% by weight of dry powder relative to the weight of the bitumen composition.

### EXAMPLES

The present invention will be explained in greater detail with reference to the examples hereinbelow. It should be noted that the terms “parts” and “%” appearing in the examples correspond to “parts by weight” and to “% by weight”, respectively, in the absence of special precisions.

### EXAMPLES

### Example A

### Preparation of a Bitumen Composition

1) Preparation of the Polymer Powder

A liquid phase having the composition below is prepared:

76% by dry weight of Latexia300 relative to the total weight of the dry powder;

9% by weight of glutamate relative to the total weight of the dry powder;

1% water.

Latexia300 is a latex sold by the company Rhodia, which was synthesized according to the process described in document WO 99/38917. The main monomers used are styrene, butadiene and acrylic acid in proportions such that the glass transition temperature obtained (Tg) is 0° C.

The liquid phase is then pumped and sprayed into a drying tower (atomizer) into which are introduced the following ingredients in dry form:

12% by weight of kaolin relative to the total weight of the dry powder

1% by weight of Sipernat D17 (silica) relative to the total weight of the dry powder

1% by weight of lime relative to the total weight of the dry powder.

A powder with a particle diameter of between 70 and 150 μm is obtained. It has good free-flowing qualities, and does not cake under normal storage conditions.

2) Preparation of the Bitumen Composition

A mass of 50 g of Shell 70-100 bitumen, which is representative of the medium-range European bitumens, is taken from a barrel and then placed in a 250 ml beaker.

This beaker is heated to 170° C., until the bitumen is totally liquid. The polymer powder of step a) is then added, and the bitumen is kept stirring for 20 minutes while maintaining the temperature at between 165 and 175° C.

The mixture is then stirred very slowly for 10 minutes in the same temperature range in order to eliminate the bubbles.

The amount of powder of Example A-1 used is 1.5% by weight of dry powder relative to the weight of bitumen.

The incorporation is easy, there is no release of water vapour and the dispersion of the powder in the bitumen composition is quick and easy.

### Example B

### Evaluation of the Bitumen Compositions

1—Preparation of Specimens

In order to be able to evaluate the bitumen compositions of the invention, tests were performed on the bitumen composition of Example A-2, on a bitumen composition without addition of powder (control), on bitumen compositions into which was incorporated an aqueous polymer dispersion (latex), and on bitumen compositions into which was incorporated solid polymer.

The conditions used for the preparation of the specimens are the same as those described in Example A-2.

The mixtures made are prepared from Shell 70-100 bitumen, which is representative of middle-range European bitumens.

A mass of 50 g of bitumen is taken from a barrel and then placed in a 250 ml beaker. This beaker is heated to 170° C. until the bitumen is totally liquid. The polymer in powder or solid form is then added, and the bitumen is kept stirring for 20 minutes while maintaining the temperature between 165 and 175° C. The mixture is then stirred very slowly for 10 minutes in the same temperature range in order to eliminate the bubbles.

The specimens intended for the mechanical tests are prepared by pouring the hot mixture into a silastene mould. 3 specimens are poured at the same time to avoid reheating the same sample several times and thus modify its thermal history. Once the bitumen has been poured into the mould, it is placed in a refrigerator in order to rigidify the specimens so that they can be stripped from the mould without risk of deformation, at a temperature below −10° C. for about 30 minutes. The rigidified specimens are then stripped from the mould.

The products evaluated are as follows:

The Polymer Powder of Example a-1

Rubber Powder

The rubber powders used are obtained from tyres (very-low-temperature grinding). One particle size was tested: 500 μm powder

2—Description of the Test for Evaluating the Cold Mechanical Properties of the Bitumen Compositions by Breaking Test

The cold mechanical behaviour of a typical bitumen material in the low temperature region, i.e. for a temperature below its glass transition temperature (Tg), is behaviour of fragile elastic type.

The fragile behaviour is characterized by sudden breaking of the material.

The mechanical behaviour of the bitumen is approached by 3-point bending tests on parallelepipedal specimens.

The bitumen specimens were poured while hot into a silicone mould, and rigidified at low temperature before stripping from the mould. The specimens are parallelepipedal and have the following dimensions:

l=11 cm

d=1 cm

w=1 cm

The tests are performed in a chamber at a temperature of −30° C., reproducing extreme conditions of use of the bitumen. Furthermore, this temperature is slightly lower than the glass transition temperature of the bitumen.

The specimens are stabilized at −30° C. for 15 minutes, and the bending test is then started. The values of the maximum force reached are compared for each type of modified bitumen.

For each modified bitumen, six specimens were broken (at −30° C.) and the average of the maximum stresses reached is determined by means of the following formula:
σ=3/2*(F1)/d·w2)

The mean maximum stress is indicated in Table I below:

TABLE I

| | Mechanical strength |
|---|---|
| Type of bitumen | at −30° C. (MPa) |
| Pure Shell (control) | 0.5 |
| Shell + 1.5% powder of Example A-1 | 2.75 |
| Shell + 1% 500 μm rubber | 0.85 |

The addition of polymer to the bitumens leads to an increase in the cold breaking stress, which means better resistance of the binder at low temperatures. However, the behaviour of the material still remains fragile.

The mechanical tests confirm the very good influence of the latex powders on bitumen. Specifically, at low temperatures, the addition of latex powders makes it possible to increase the resistance to cold.

1. A method for improving the physicochemical properties of bitumen, comprising adding a sufficient amount of polymer powder to the bitumen compositions, the said powder having a particle diameter of between 1 and 150 μm.

2. The method according to claim 1, characterized in that the polymer powder is prepared from at least one ethylenically unsaturated monomer, which may be chosen from styrene, butadiene, C₁-C₁₂ alkyl acrylic and/or methacrylic esters, vinyl esters, acrylamide and/or methacrylamide, and C₁-C₁₂ alkyl derivatives thereof.

3. The method according to claim 2, characterized in that the polymer powder is prepared from monomer comprising at least styrene and butadiene.

4. The method according to claim 3, characterized in that the polymer powder is prepared from at least one additional monomer containing one or more functional group(s) chosen from carboxyl, acid anhydride, hydroxyl, amide, amino and glycidyl groups.

5. The method according to claim 4, characterized in that the polymer powder is prepared from at least one additional monomer chosen from acrylic acid, methacrylic acid, fumaric acid, itaconic acid, crotonic acid, maleic acid, maleic anhydride, mesaconic acid and glutaconic acid, or mixtures thereof.

6. The method according to claim 5, characterized in that the polymer powder is prepared from at least styrene, butadiene and acrylic acid monomers.

7. The method according to claim 6, characterized in that the polymer powder is prepared from a mixture of monomers comprising 92% to 99.9% by weight of at least one ethylenically unsaturated monomer, and 0.1% to 8% and more particularly 2% to 5% by weight of at least one monomer containing a carboxylic function.

8. The method according to claim 7, characterized in that the polymer powder is prepared from a mixture of ethylenically unsaturated monomers chosen so as to obtain a polymer with a glass transition temperature of between −40° C. and +35° C.

9. The method according to claim 8, characterized in that the glass transition temperature is between −40° C. and +5° C.

10. The method according to claim 9, characterized in that the glass transition temperature is between −40° C. and +1° C.

11. The method according to claim 10, characterized in that the polymer powder also contains a sufficient amount of a polypeptide containing from 2 to 100 amino acids.

12. The method according to claim 11, characterized in that the polypeptide is chosen from sodium glutamate, sodium aspartate and sodium hydroxyglutamate.

13. The method according to claim 12, characterized in that the polypeptide is incorporated in an amount of between 2 and 40 parts by weight per 100 parts by weight of polymer powder.

14. The method according to claim 13, characterized in that the polymer powder also contains a sufficient amount of a water-soluble compound (C) chosen from sugars and derivatives thereof and/or polyelectrolytes belonging to the family of weak polyacids.

15. The method according to claim 14, characterized in that the polymer powder also contains a sufficient amount of an amino acid (D) or derivatives thereof.

16. The method according to claim 15, characterized in that the amino acid (D) or derivatives thereof are chosen from arginine, lysine, histidine, glutamic acid, aspartic acid, hydroxyglutamic acid, sodium glutamate, sodium aspartate and sodium hydroxyglutamate.

17. The method according to claim 16, characterized in that the polymer powder also contains a sufficient amount of a powdered mineral filler (F) with a particle size of less than 20 μm.

18. The method according to claim 16, characterized in that the amount of polymer powder introduced into the bitumen composition is between 0.5% and 20% by weight of dry powder relative to the weight of the bitumen composition.

19. The method according to claim 18, characterized in that the amount of polymer powder introduced into the bitumen composition is between 0.5% and 10% by weight of dry powder relative to the weight of the bitumen composition.

20. The method according to claim 19, characterized in that the amount of polymer powder introduced into the bitumen composition is between 0.5% and 3% by weight of dry powder relative to the weight of the bitumen composition.

21. The method according to claim 20, characterized in that the bitumen is chosen from natural bitumens, pyrobitumens and artificial bitumens, or mixtures thereof.

22. The method according to claim 21, characterized in that the bitumen is chosen from asphalt and maltha.

23. The method according to claim 22, characterized in that the bitumen chosen is asphalt.

24. The method for improving the physicochemical properties of the bitumen composition, comprising the following steps:
1—The bitumen composition is heated to a temperature of between 140 and 190° C.;
2—A sufficient amount of polymer powder with a particle size of between 1 and 150 μm is added to the bitumen composition of step 1 with stirring.

25. Bitumen composition produced by the process according to claim 24.

26. The method for preparing hot mixes according to claim 24 further comprising the step of additional to the preceding process, which consists in adding, with stirring and at a temperature of between 140 and 190° C., aggregates to the bitumen composition.

27. The method The method for preparing cold mixes, comprising the following steps:
1—a sufficient amount of polymer powder is incorporated into a bitumen emulsion with stirring at room temperature;
2—the emulsion obtained in step (1) is spread onto a road to obtain a uniform layer of the mixture obtained in step (1);
3—the aggregates and fillers are spread on top of the layer obtained in step (2), in the form of a uniform layer;
4—the bitumen emulsion is broken.

28. The method according to claim 27, characterized in that the amount of polymer powder introduced into the bitumen composition is between 0.5% and 20% by weight of dry powder relative to the weight of the bitumen composition.

29. The method according claim 28, characterized in that the amount of polymer powder introduced into the bitumen composition is between 0.5% and 10% by weight of dry powder relative to the weight of the bitumen composition.

30. The method according to either of claim 29, characterized in that the amount of polymer powder introduced into the bitumen composition is between 0.5% and 3% by weight of dry powder relative to the weight of the bitumen composition.
